(19) United States
(12) Patent Application Publication
(10) Pub. No.: US 2008/0260962 A1
(43) Pub. Date: Oct. 23, 2008

(54) Glove with gripping dots and a method of making same

(76) Inventor: Cole Williams, Bainbridge Island, WA (US)

Correspondence Address: JAMES E. BRUNTON, ESQ., P. O. BOX 29000, GLENDALE, CA, 91209, US

(21) Appl. No.: 12/214,945

(22) Filed: Jun. 23, 2008

Related U.S. Application Data
(62) Division of application No. 11/187,087, filed on Jul. 22, 2005.

(51) Int. Cl. C08F 2/46

(52) U.S. Cl. 427/487

(57) ABSTRACT

A gripping glove and the method of making same and a material and the method of making the sheet material that is ideally suited for use in constructing the gripping gloves which, in use, exhibit superior grip characteristics.

This is a Divisional Application of co-pending U.S. Ser. No. 11/187,087 filed Jul. 22, 2005.

### BACKGROUND OF THE INVENTION

1. Field of the Invention

The present invention relates generally to gloves and methods for making same. More particularly, the invention concerns a special glove-making sheet material and the method of making the same that is ideally suited for use in constructing improved gloves of the character that have gripping dots provided at strategic locations on both the exterior and interior surfaces of the glove.

2. Discussion of the Prior Art

Gloves of various construction are used for many work-related and recreational purposes such as gardening, operation of various tools, driving, shooting, playing ball, motorcycling and a wide variety of outdoor activities. Frequently the prior art gloves have been made from leather and several different types of treated, relatively hard surfaced fabrics. Attempts have also been made in the past to produce stretchable knitted gloves that are comfortable to wear, will protect the wearer's hands and at the same time will permit the user to securely grip and efficiently manipulate various types of articles.

Most common of the prior art gloves are those made by cutting various sheet fabrics according to patterns, sewing the sheet fabrics together along seam lines to form a precursor sleeve and then reversing the precursor glove to form a finished glove. These cut and sewn gloves have been made from various materials, both natural such as leather, and manmade, such as any of a wide range of sheet goods, woven, non-woven, or knit fabric. Frequently these sheet fabrics are laminated or coated to secondary surfacing materials, while still in their original sheet form. The applied surface material is intended to enhance the durability as well as the gripping characteristics of the palm side of the gloves. Such gloves, with the soft, smooth interior surfaces and with aggressive tenacious gripping surfaces on the outside, are not stable relative to the wearer's skin. After performing a task that involves the secure gripping of the article being held, the glove typically must be pulled back on or adjusted relative to the hand.

As will be discussed in greater detail hereinafter, in accordance with one form of the present invention both sides of the starting material, while still in the sheet form, is coated with a friction surface material. One method of preparing the friction surface of the material is to apply a multiplicity of dots of a polymer emulsion, such as a liquid vinyl emulsion, using a squeegee to force the emulsion through apertures of a stencil onto the first surface of the sheet goods and thereafter radiation curing the emulsion into a rubber-like consistency. The sheet material is now in the form of a fabric with friction/gripping materials bonded and/or cured onto both sides. It is thereafter cut, according to the glove pattern and then sewn into the glove. In this way, a glove is made that uniquely has friction, griping materials both on the inside and the outside of the palms of the glove.

### SUMMARY OF THE INVENTION

It is an object of the present invention to provide a special sheet material and the method of making the same that is ideally suited for use in constructing improved gloves of the character that exhibit superior grip characteristics.

Another object of the invention is to provide a method and apparatus for making an improved glove of the aforementioned character from the special sheet material of the invention wherein the glove is provided with a multiplicity of gripping dots located at strategic locations on both the exterior and interior surfaces of the glove.

Another object of the invention is to provide a glove as described in the preceding paragraphs that stabilizes the interior of the glove with the skin of the wearer.

Another object of the invention is to provide a glove of the aforementioned character that enables the user to securely grip and readily manipulate various types of articles.

Another object of the invention is to provide a glove of the aforementioned character that exhibits a high degree of comfort and durability in use.

A particular object of the invention is to provide a glove of the character described that is highly versatile and durable in use and one which enables the user to deftly manipulate various objects.

Another object of the invention is to provide a method of making a glove of the character described in the preceding paragraphs which is simple and straightforward, does not require the use of complicated equipment and can be performed by unskilled workmen with a minimum of training.

In summary, one form of the method of the invention for making the gripping glove of the invention comprises the steps of first depositing a multiplicity of closely-spaced small dots of a polymer emulsion onto the first surface of a sheet material. The dots of polymer emulsion are then radiation cured to form a multiplicity of cured dots having a rubber-like consistency. This done, the coated sheet material is turned over and a multiplicity of dots of a polymer emulsion are deposited onto the second surface of the material. Thereafter the dots of the polymer emulsion deposited on the second surface are radiation cured into a rubber-like consistency. The glove-making material thusly formed is appropriately cut to form the palm side of the glove. The palm side of the glove is then sewn to material forming the backside of the glove. By this means, a glove is made that now has friction, gripping materials both on the inside and the outside of the palm and finger portions of the glove.

### BRIEF DESCRIPTION OF THE DRAWINGS

FIG. 1 is a generally perspective, exploded view showing stencil component of the apparatus of the invention superimposed over the first surface of a starting material, such as a sheet of fabric.

FIG. 2 is a generally perspective, diagrammatic view showing the curing, or irradiation means of the apparatus of the invention superimposed over the starting material of FIG. 1 as it appears following the deposition of a multiplicity of gripping dots on the first surface of the material to form the first type of coated material of the invention having gripping dots on only one side of the material.

FIG. 3 is a generally perspective view, similar to FIG. 1, but showing stencil component of the apparatus of the invention superimposed over the second, uncoated surface of the first type of coated material of the invention.

FIG. 4 is a generally perspective view, similar to FIG. 2, but showing the irradiation means of the apparatus of the invention superimposed over the second, coated surface of the first type of coated material of the invention to form a second type of coated material of the invention.

FIG. 5 is a generally perspective view of the second type of coated material of the invention having gripping dots formed on both the first and second sides of the starting material.

FIG. 6 is a generally perspective, exploded view showing in the lower portion of the drawing the second type of coated material of the invention illustrated in FIG. 5 cut into the general shape of the lower portion of one form of the gripping glove of the invention and showing in the upper portion of the drawing the starting material of the invention illustrated in FIG. 1 cut into the general shape of the upper portion of one form of the gripping glove of the invention.

FIG. 7 is a generally perspective view of one form of the assembled glove of the invention having gripping surfaces on both the inner and outer surfaces of the lower portion of the glove.

FIG. 8 is an enlarged cross-sectional view taken along lines 8-8 of FIG. 7.

FIG. 9 is an enlarged cross-sectional view taken along lines 9-9 of FIG. 7.

FIG. 10 is a generally perspective view of an alternate form of the assembled glove of the invention having gripping surfaces only on the inner surface of the lower portion of the glove and having a lower surface that exhibits a higher coefficient of friction than the surfaces of the starting material of the invention.

FIG. 11 is an enlarged cross-sectional view taken along lines 11-11 of FIG. 10.

FIG. 12 is an enlarged cross-sectional view taken along lines 12-12 of FIG. 10.

### DESCRIPTION OF THE INVENTION

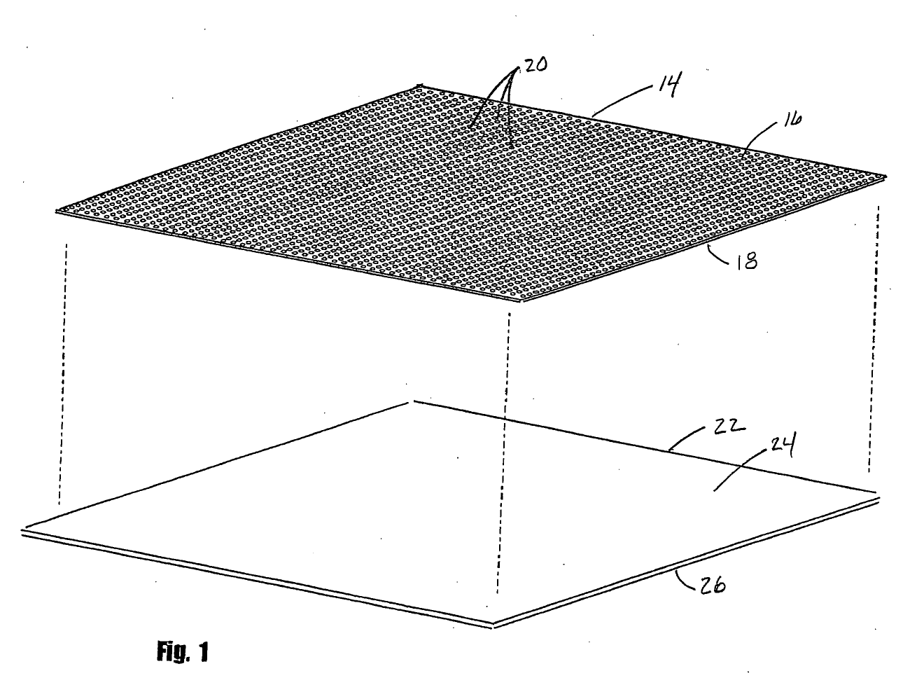

Referring to the drawings and particularly to FIGS. 1 through 7, one form of the apparatus of the invention for making a glove having gripping surfaces thereon is there shown. In the present form of the invention, the apparatus comprises a substantially rigid, stencil component 14 that has generally planar, spaced-apart opposing surfaces 16 and 18 and is provided with a multiplicity of spaced-apart generally dot size apertures 20 there-through. In FIG. 1, stencil component 14 is shown superimposed over a sheet of starting material 22 having first and second sides 24 and 26.

Starting material 22 may be a natural material, such as leather, or it may comprise synthetic, manmade sheet goods, such as woven, non-woven, and knit fabric, for example, a knit fabric having elastic characteristics.

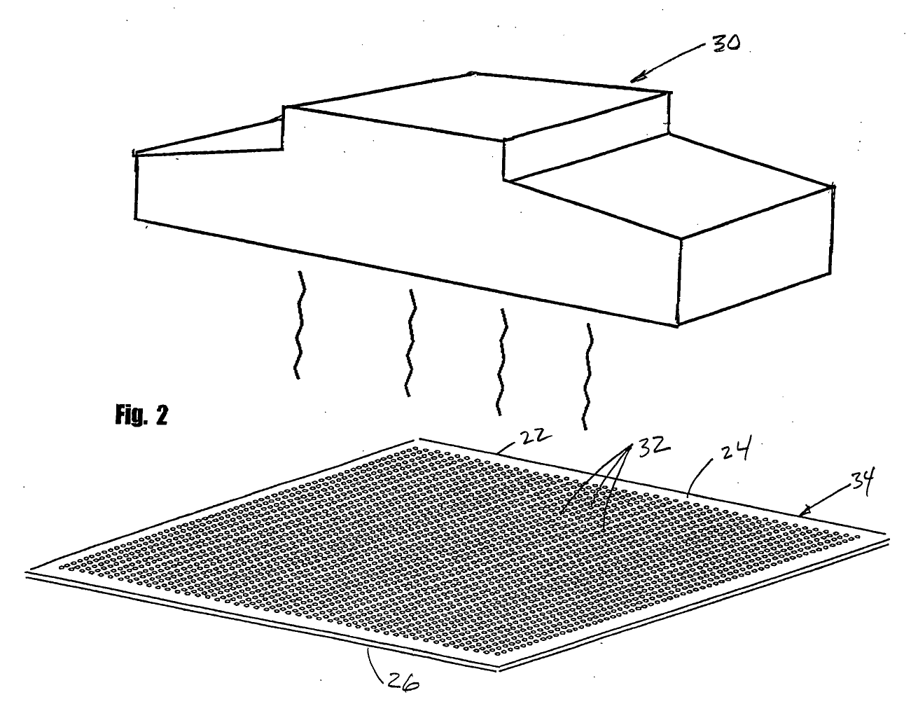

Turning to FIG. 2, it can be seen that the apparatus of the invention also includes curing or irradiation means, generally designated by the numeral 30, for irradiating the precursor assemblies of the invention in a manner presently to be described.

One form of the method of the invention concerns a novel process for making a material suitable for use in constructing a glove of novel design. This process here comprises the step of depositing on the first side 24 of the starting material 22 a multiplicity of closely-spaced dots 32 of a selected one of a polymer emulsion or a liquid vinyl emulsion (FIG. 2). This step is accomplished by using an appropriate squeegee (not shown), to controllably force a liquid emulsion, such as a liquid vinyl emulsion, through the apertures 20 formed in the stencil 14. The closely-spaced vinyl dots 32 thusly deposited on the first surface of the material are cured using the previously mentioned radiation means, or irradiating device 30, to form a first precursor material 34 having a multiplicity of first cured dots on the first side of the material.

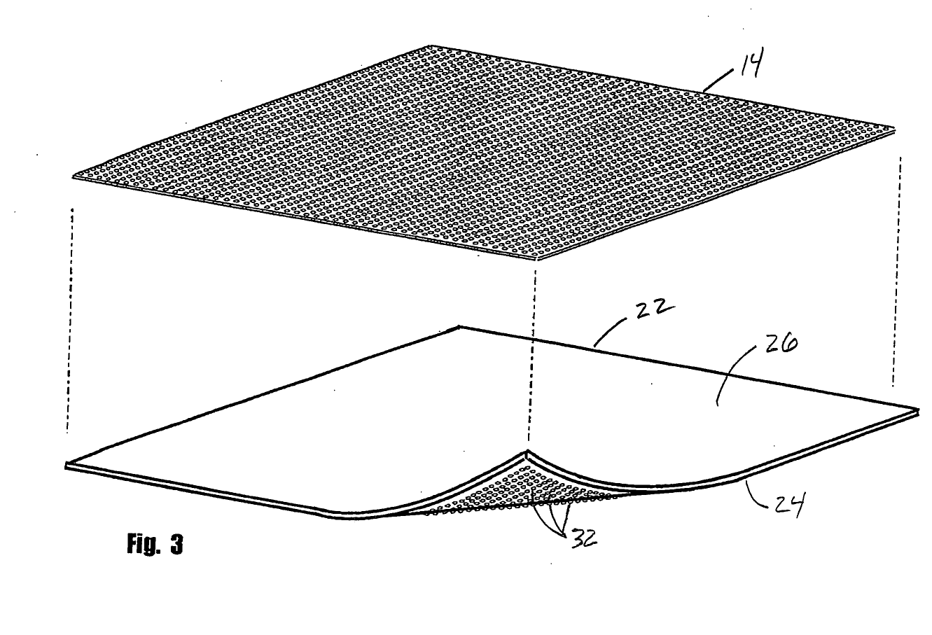

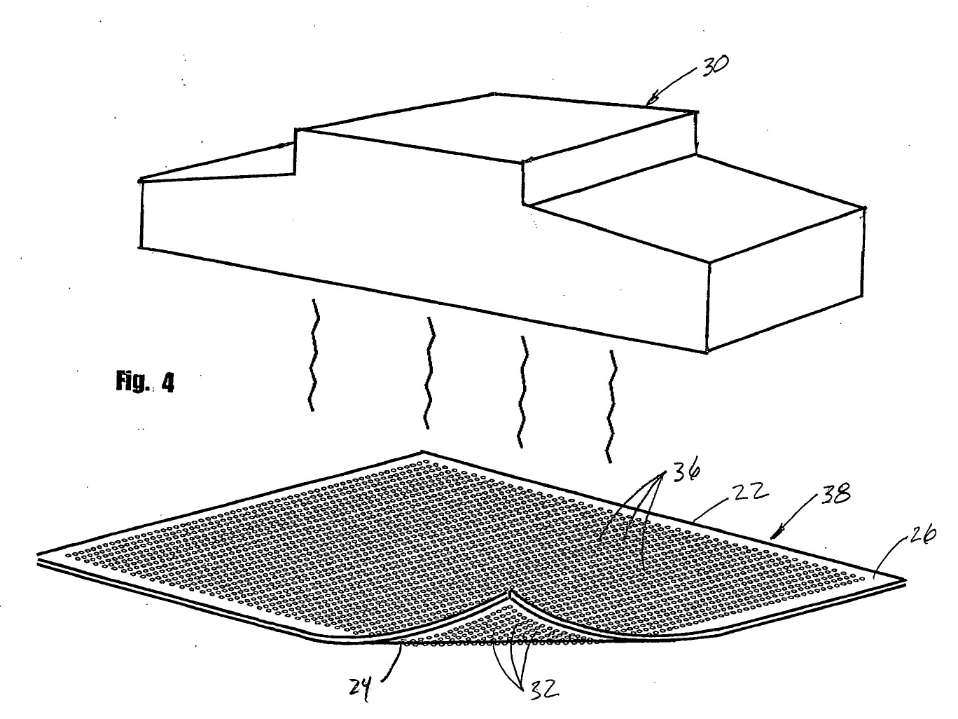

Next, the precursor material 34 is turned over in a manner shown in FIG. 3 of the drawings and a multiplicity of closely-spaced dots of liquid vinyl emulsion are deposited on the second surface of the starting material. This done, the radiation means of the invention 30 is used to cure the deposited dots of the liquid vinyl emulsion to form a multiplicity of second cured dots 36 (see FIG. 4).

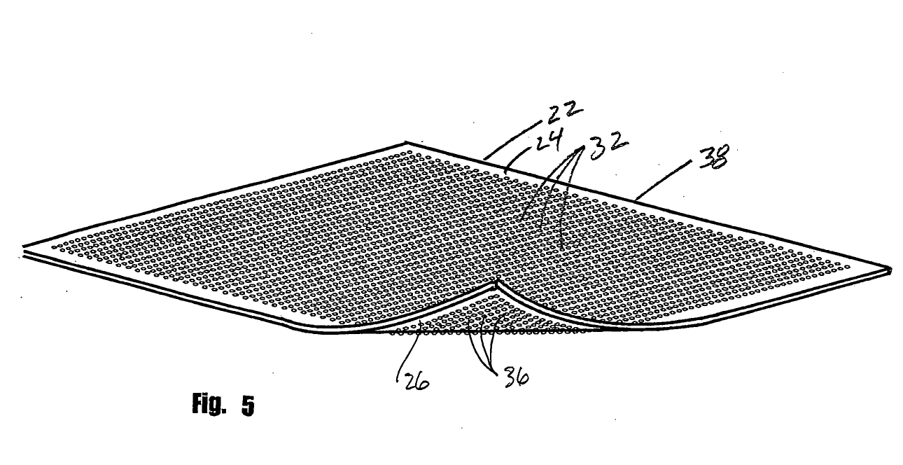

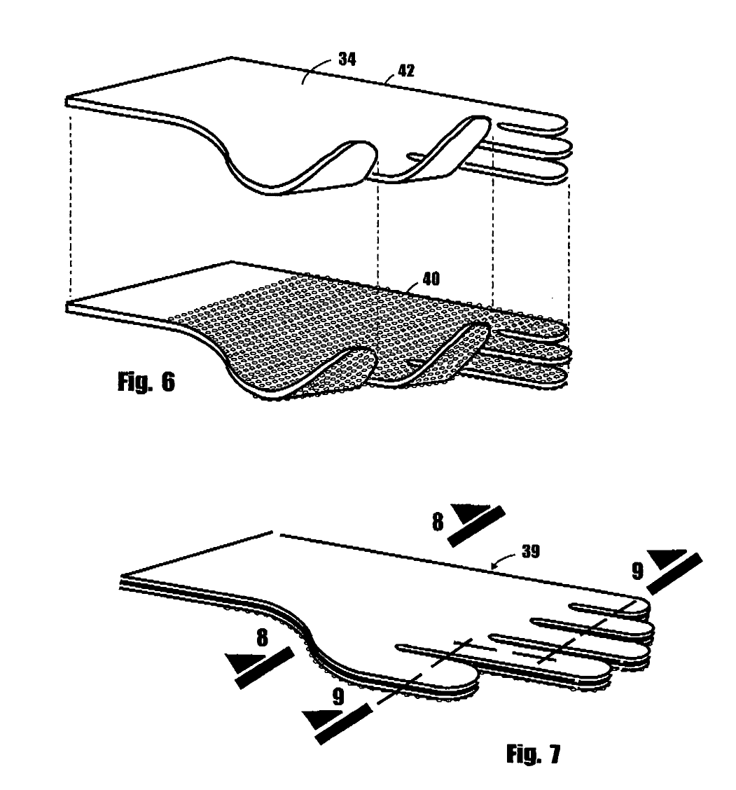

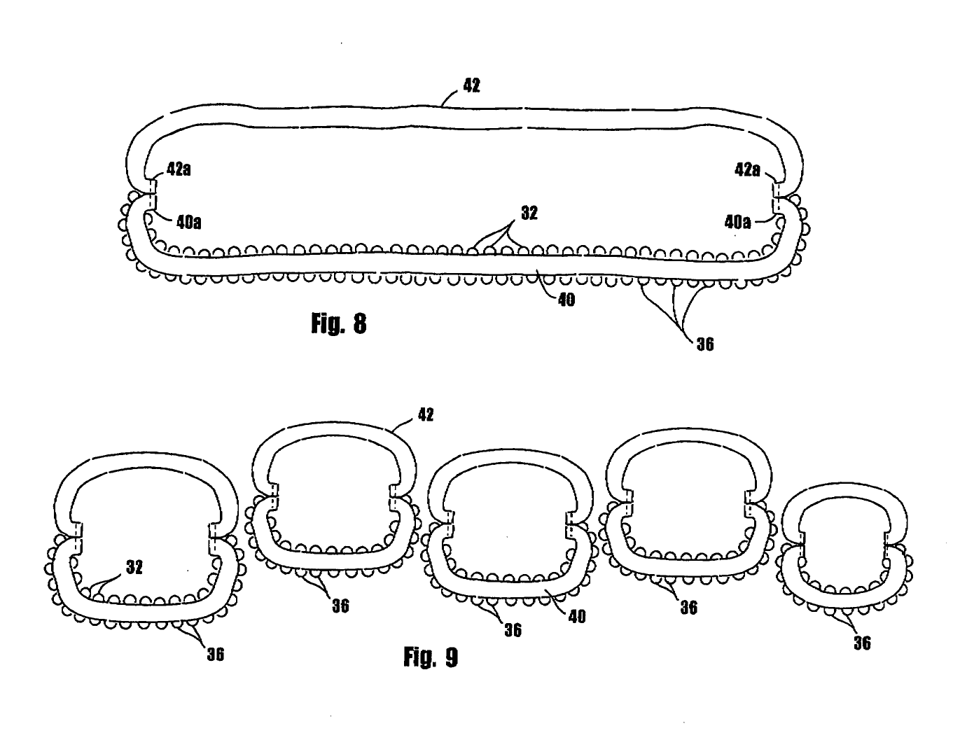

In a manner next to be described the novel glove-making material 38 thusly produced (FIG. 5) is used to make a novel, generally hand-shaped glove. In one embodiment of the invention, this method comprises the steps of first cutting the glove-making material 38 to form the palm side 40 of the glove (FIG. 6). Next, a selected one of the sheets of starting material 22, the first precursor material 34 and the glove-making material 38 (shown in FIG. 6 as the first precursor material 34), is appropriately cut to form the backside 42 of the glove. The palm side of the glove is then affixed to the backside of the glove as, for example, by sewing along the periphery 42a of the backside of the glove to the periphery 40a of the palm side of the glove. The precursor glove thus formed is reversed, that is turned inside out, to form one embodiment of the novel gripping glove of the invention which is of the character shown in FIGS. 8 and 9 of the drawings.

It is apparent from a study of FIGS. 6, 8 and 9 of the drawings that when the backside of the glove is cut from the starting material 22 and the palm side of the glove is cut from the glove making material 38, the gripping glove thus formed has gripping dots on both the inner and outer surface of the palm and finger portions of the glove and the backside of the glove has smooth inner and outer surfaces.

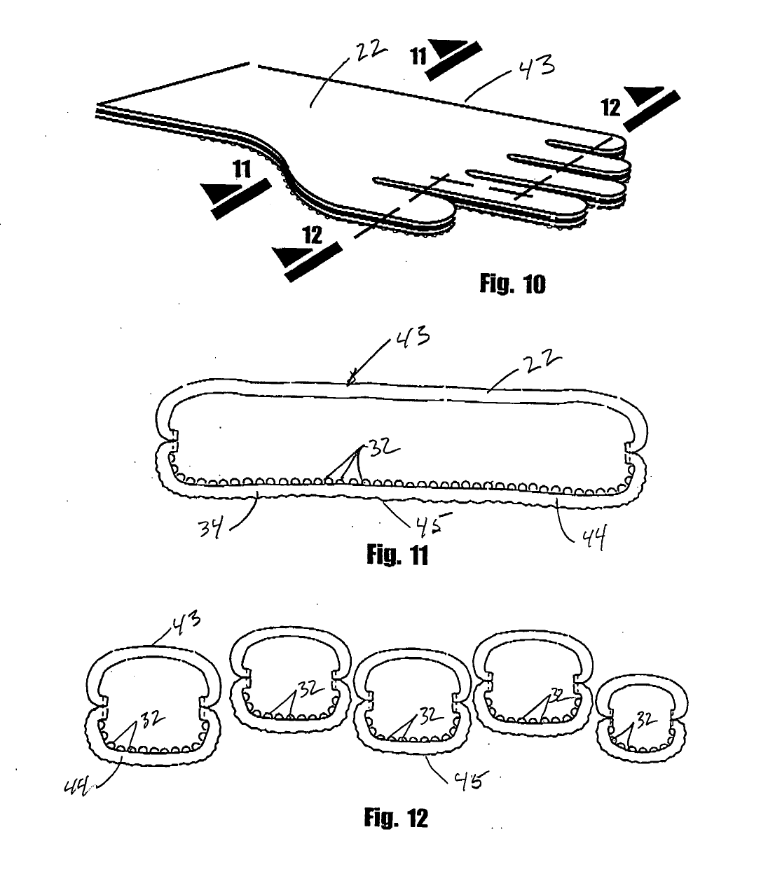

In the alternate embodiment of the invention depicted in FIGS. 10, 11 and 12, the backside of the glove, shown here as 43, is cut from the starting material 22 and the palm and finger portions 44 are cut from a specially selected first precursor material. In this form of the invention only the inside of the palm and finger portions of the gripping glove have gripping dots formed thereon. The outer surface of the palm and finger portions of this specially selected first precursor material has been treated to provide a surface 45 that exhibits an increased coefficient of friction.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A method of making a glove-making material using a sheet of starting material having first and second sides and an apparatus comprising a stencil member having a plurality of apertures therethrough and a curing means for curing polymer emulsion, said method comprising the steps of:
(a) depositing the first side of the starting material a multiplicity of spaced-apart dots of a polymer emulsion;
(b) using the radiation means, curing said dots of polymer emulsion to form a multiplicity of first cured dots;
(c) depositing on the second side of the starting material a multiplicity of spaced-apart dots of a polymer emulsion; and
(d) using the radiation means, curing said dots of polymer emulsion deposited on the second side of the starting material to form a multiplicity of second cured dots.

2. The method as defined in claim 1 in which said starting material comprises a knitted material.

3. The method as defined in claim 1 in which said multiplicity of dots of polymer emulsion are deposited on the first and second surfaces of the starting material by forcing the emulsion through the apertures formed in the stencil.

4. A method of making a glove-making material using a sheet of starting material having first and second sides and an apparatus comprising a stencil member having a plurality of apertures therethrough and a curing means for curing vinyl emulsion, said method comprising the steps of:
(a) superimposing the stencil over the first surface of the starting material;
(b) depositing a multiplicity of dots of liquid vinyl on the first surface of the starting material by forcing the liquid vinyl through said apertures formed in said stencil to form an uncured first precursor;
(c) using the curing means, curing said liquid vinyl deposited on the first surface of the starting material to form a first cured precursor;
(d) turning said first cured precursor over to expose the second surface of the starting material;
(e) superimposing the stencil over the second surface of the starting material;
(f) depositing a multiplicity of dots of liquid vinyl on at least a portion of the second surface of the starting material by forcing the liquid vinyl through said apertures formed in said stencil to form an uncured second precursor; and
(g) using curing means, curing said liquid vinyl deposited on said second surface of the starting material to form the glove-making material.

5. A method of making a glove having a palm side and a backside comprising the steps of:
(a) making a glove-making material using a sheet of starting material having first and second sides and an apparatus comprising a stencil member having a plurality of apertures therethrough and a curing means for curing a polymer, said method comprising the steps of:
(i) depositing the first side of the starting material a multiplicity of spaced-apart dots of a polymer emulsion;
(ii) using the radiation means, curing said dots of polymer emulsion to form a multiplicity of first cured dots;
(iii) depositing on the second side of the starting material a multiplicity of spaced-apart dots of a polymer emulsion; and
(iv) using the radiation means, curing said dots of polymer emulsion deposited on the second side of the starting material to form a multiplicity of second cured dots;
(b) cutting said glove-making material to form the palm side of the glove;
(c) cutting the sheet of starting material to form the backside of the glove; and
(d) affixing said palm side of the glove to said backside of the glove.

6. The method as defined in claim 5 in which said palm side of the glove is affixed to said backside of the glove by sewing.

7. The method as defined in claim 5 in which the starting material comprises a synthetic material.

8. The method as defined in claim 5 in which the starting material comprises a natural material.

9. The method as defined in claim 5 in which the starting material comprises leather.

10. The method as defined in claim 5 in which the starting material comprises a fabric that is treated to provide a surface having an increased coefficient of friction.

11. The method as defined in claim 5 in which the starting material comprises a knitted fabric.
